(19) United States
(12) Patent Application Publication
(10) Pub. No.: US 2010/0135894 A1
(43) Pub. Date: Jun. 3, 2010

(54) METHOD OF PRODUCING CHLORINE DIOXIDE, AND ALKALINE COMPOSITION FOR CHLORINE DIOXIDE PRODUCTION TO BE USED IN THE METHOD

(75) Inventors: Shigeo Asada, Osaka (JP); Takashi Shibata, Osaka (JP); Koji Abe, Osaka (JP)

Correspondence Address: BUCHANAN, INGERSOLL & ROONEY PC, POST OFFICE BOX 1404, ALEXANDRIA, VA, 22313-1404, US

(73) Assignee: TAIKO PHARMACEUTICAL CO., LTD., Suita-shi (JP)

(21) Appl. No.: 12/665,696

(22) PCT Filed: Jun. 20, 2008
(86) PCT No.: PCT/JP2008/061339

§ 371 Date: Jan. 11, 2010

(30) Foreign Application Priority Data
Jun. 26, 2007 (JP) 2007-167756

(51) Int. Cl. C01B 11/02

(52) U.S. Cl. 423/477

(57) ABSTRACT

Disclosed is a method for producing chlorine dioxide using hypochlorite, chlorite and an acidic substance, wherein sodium hypochlorite and sodium chlorite are mixed together in advance, and then hydrochloric acid is added into the mixture liquid.

### TECHNICAL FIELD

The present invention relates to a method of producing chlorine dioxide and an alkaline composition for chlorine dioxide production to be used in the method. More specifically, this invention relates to a chlorine dioxide producing method which allows increase in the production efficiency (generation efficiency) of chlorine dioxide while reducing the chlorine gas generation, and an alkaline composition for chlorine dioxide production to be used in such method.

### BACKGROUND ART

According to a conventional method, chlorine dioxide gas is generated in the following manner. That is, (I) as shown by the following Formula (1), sodium hypochlorite and hydrochloric acid are reacted together to generate chlorine gas (Chemical Formula 1), then (II) the generated chlorine gas and sodium hypochlorite are reacted together to generate (produce) chlorine dioxide gas (Chemical Formula 2) (see Patent Document 1).
Patent Document 1: Japanese Patent Application “Kokai” No. 2002-220207

{Chemical Formula 1}

NaClO+2HCl→Cl₂↑+NaCl+H₂O (I)

[Chemical Formula 2]

Cl₂+2NaClO₂→2ClO₂+2NaCl (II9

### DISCLOSURE OF THE INVENTION

However, in the above-described conventional method of producing chlorine dioxide, it is necessary to generate a great amount of chlorine gas temporarily. Therefore, this method would be subjected to various restrictions imposed by the Industrial Safety and Health Law and other applicable law(s) and would require sufficient caution and care in handling. For instance, a Japan Waterworks Association Gazette (Issue No. 565, p 155) states that presence of chlorine gas, regardless of its amount, necessitates restriction by the Industrial Safety and Health Law and requires the following safety measures to be taken.

1. Measures should be taken on the layout of instrument and piping, their forming materials and structures so that they are not damaged.

2. A chlorine gas leak detector must be placed so that the gas production may be stopped in the event of leakage.

3. In the case of indoor production, a ventilator needs to be installed.

4. Display a notice such as “Restricted Area”, “Caution Danger”, etc.

As a method of producing chlorine dioxide other than the above method, there is a known production method called “two-(liquid) component method”, that is, a method of producing chlorine dioxide by reacting chlorite and an acidic substance. In the case of production of chlorine dioxide by this method, generation of chlorine gas is diminished, so the above-described problems do not occur.

However, this method would create a new problem of need for the disposal of waste acidic liquid. For instance, in the course of production of chlorine dioxide through the reaction between sodium hypochlorite and an acidic substance, when the efficiency of the reaction is poor, the method sometimes uses an excess amount of the acidic substance as much as from 2 to 2.5 times the theoretical amount.

Furthermore, in this method, there is generated chlorate (sodium chlorate), which is a kind of hazardous substances classified as a deleterious substance under the Poisonous and Deleterious Substance Control Law and which, when inhaled, causes such symptoms as mucosal irritation, nausea, sickness, abdominal pain, diarrhea, cyanosis, breathing difficulty and has a moderate eye irritant property. Therefore, after the reaction (after the production), there is a need to appropriately dispose the processing liquid containing the excess amount of acidic substance or the processing liquid containing chlorate.

The present invention has been made in view of the above-described state of the art. The objective of the invention is to provide a method of producing chlorine dioxide, capable of simultaneously solving the problem of waste liquid disposal which occurs due to excessive use of acidic substance, without generation and subsequent accumulation of chlorine gas.

For accomplishing the above-noted object, according to the first characterizing feature of the present invention, there is provided a method of producing chlorine dioxide with the use of hypochlorite, chlorite and an acidic substance, characterized in that the method comprises the steps of mixing the hypochlorite and the chlorite in advance and subsequently adding the acidic substance to the resultant mixture solution.

According to the second characterizing feature of the present invention, in the producing method described above, the method is executed with preventing introduction of carbon dioxide to a tank reserving the hypochlorite.

According to the third characterizing feature of the present invention, in the producing method described above, a mixing ratio of the acidic substance is set to 2 mol or less, relative to 1 mol of the hypochlorite.

According to the fourth characterizing feature of the present invention, there is provided an alkaline composition for use in production of chlorine dioxide with addition of an acidic substance, characterized in that said alkaline composition comprises a mixture of hypochlorite and chlorite.

According to the fifth characterizing feature of the present invention, said alkaline composition is stored at a low temperature.

### EFFECT OF THE INVENTION

With the above-described chlorine dioxide producing method provided by the present invention, hypochlorite and chlorite can be mixed uniformly, before the addition of the acidic substance. If the acidic substance is added to the mixture under this condition, chlorine dioxide is produced according to a reaction formula (III) (Chemical Formula 3). As a result, it is possible to prevent generation and subsequent accumulation of chlorine gas, so that the production of chlorine dioxide can be executed safely.

[Chemical Formula 3]

NaClO+2NaClO₂+2HCl→2ClO₂+3NaCl+H₂O (III)

With this arrangement, there is no need for a system or for a space to collect chlorine gas. So, as compared with the conventional method executing the reaction with hypochlorite after collection of generated chlorine gas, the reaction system can be simpler.

Furthermore, in the case of the conventional method, there was a further need to mix an excess amount of acidic substance for increasing the reaction efficiency. However, according to the present inventive producing method, no such excess amount of acidic substance needs to be mixed, such that the problem of waste liquid has been eliminated and the cost required for the excess amount of acidic substance can be reduced as well. Moreover, as compared with the conventional method, the present inventive method allows elimination of the step of adding the excess amount of acidic substance.

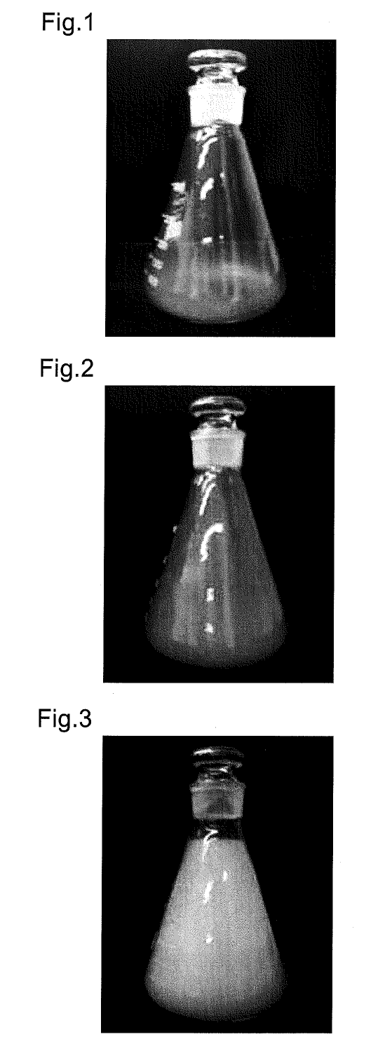

### BRIEF DESCRIPTION OF DRAWINGS

[FIG. 1] is a photo (substitute for a drawing) showing inside of a flask after introduction of ammonium gas in Example 1 (inventive method) (the photo is used as a substitute for a drawing since it is extremely difficult to prepare a drawing according to the formal drawing technique that shows the condition of the inside of the flask to illustrate the presence/absence of white smoke in order to confirm the presence/absence of chlorine gas generated inside the flask).

[FIG. 2] is a photo (substitute for a drawing) showing inside of the flask after introduction of ammonium gas in Comparison Example 1 (three-liquid component simultaneous introducing method) (the photo is used as a substitute for a drawing since it is extremely difficult to prepare a drawing according to the formal drawing technique that shows the condition of the inside of the flask to illustrate the presence/absence of white smoke in order to confirm the presence/absence of chlorine gas generation inside the flask).

[FIG. 3] is a photo (substitute for a drawing) showing inside of the flask after introduction of ammonium gas in Comparison Example 2 (conventional method) (the photo is used as a substitute for a drawing since it is extremely difficult to prepare a drawing according to the formal drawing technique that shows the condition of the inside of the flask to illustrate the presence/absence of white smoke in order to confirm the presence/absence of chlorine gas generation inside the flask).

### BEST MODE OF EMBODYING THE INVENTION

The present invention relates to a method of producing chlorine dioxide with the use of hypochlorite, chlorite and an acidic substance, characterized in that the method comprises the steps of mixing the hypochlorite and the chlorite in advance and subsequently adding the acidic substance to the resultant mixture solution.

In the present invention, in the course of the preliminary mixing of hypochlorite and chlorite, these are mixed uniformly. Then, when an acidic substance is added to the resultant uniform mixture of hypochlorite and chlorite, chlorine dioxide can be produced according to the reaction formula of Formula 3 shown above. In this, since generation and accumulation of chlorine gas can be avoided, the production of chlorine dioxide can be executed safely.

In this invention, in the preliminary mixing of hypochlorite and chlorite, a stirring operation must achieve the homogenous mixing for a predetermined period with a stirring means or the like. Preferably, the hypochlorite and chlorite are mixed to such a degree in terms of the molecular level for instance that almost all hypochlorite molecules and chlorite molecules are positioned adjacent to each other. With mixing to such degree, generation and subsequent accumulation of chlorine gas can be prevented in a reliable manner.

[Hypochlorite]

Some non-limiting examples of the hypochlorite used in the present invention include hypochlorite alkaline metal salts, and hypochlorite alkaline earth metal salts.

Some non-limiting examples of the hypochlorite alkaline metal salt include sodium hypochlorite, potassium hypochlorite, and lithium hypochlorite. Some non-limiting examples of the hypochlorite alkaline earth metal salt include calcium hypochlorite, magnesium hypochlorite, and barium hypochlorite. Of these examples, sodium hypochlorite and potassium hypochlorite are preferred for their readiness of availability and sodium hypochlorite is most preferred. These hypochlorites can be used singly or in combination of two or more kinds thereof.

[Chlorite]

Some non-limiting examples of the chlorite used in the present invention include chlorite alkaline metal salts, and chlorite alkaline earth metal salts.

Some non-limiting examples of the chlorite alkaline metal salt include sodium chlorite, potassium chlorite, and lithium chlorite. Some non-limiting examples of the chlorite alkaline earth metal salt include calcium chlorite, magnesium chlorite, and barium chlorite. Of these examples, sodium chlorite and potassium chlorite are preferred for their readiness of availability and sodium chlorite is most preferred. These chlorites can be used singly or in combination of two or more kinds thereof.

[Acidic Substance]

Some non-limiting examples of acidic substance used in the present invention include inorganic acids such as hydrochloric acid, sulfuric acid, sulfurous acid, thiosulfuric acid, nitric acid, nitrous acid, iodic acid, phosphoric acid, phosphorous acid, sodium hydrogensulfate, potassium hydrogensulfate, and chromic acid, and organic acids such as formic acid, acetic acid, propionic acid, butyric acid, lactic acid, pyruvic acid, citric acid, malic acid, tartaric acid, gluconic acid, glycolic acid, fumaric acid, malonic acid, maleic acid, oxalic acid, succinic acid, acrylic acid, crotonic acid, oxalic acid, glutaric acid, etc. However, the invention is not limited to these. These acidic substances can be used singly or in combination of two or more kinds thereof.

[Mixing Ratio]

In the present invention, in the production of chlorine dioxide, the mixing ratio of hypochlorite, chlorite and an acidic substance is preferably from 2 to 3 mol of chlorite and from 1.5 to 2 mol of acidic substance, relative to 1 mol of hypochlorite. In the case of less than 2 mol of chlorite relative to 1 mol of hypochlorite, there remains un-reacted chlorite and there is a possibility of chlorine gas generation. Furthermore, in the case of more than 3 mol of chlorite and also in the case of more than 2 mol of acidic substance relative to 1 mol of hypochlorite, there is a possibility of deterioration in the efficiency due to excess amount of chlorite or acidic substance remaining, and of a difficulty in waste disposal as well.

Even more preferred range is from 2 to 2.2 mol of chlorite and from 1.8 to 2 mol of acidic substance, relative to 1 mol of hypochlorite.

[Others]

In the present inventive producing method, for maintaining stability of hypochlorite, introduction of air into the reservoir tank is preferably avoided. For instance, the introduction of air can be prevented by such technique as feeding an inactive gas such as nitrogen, argon, etc.

Furthermore, in order to maintain the stability of hypochlorite, introduction of carbon dioxide in particular is preferably avoided. In this case, the introduction of carbon dioxide can be avoided by such technique as providing an absorbent agent for carbon dioxide between the reservoir tank and the ambient air inlet, feeding the air free from carbon dioxide, or an inactive gas such as nitrogen, argon, etc. is fed into the reservoir tank.

For executing the uniform mixing of hypochlorite and chlorite in a reliable manner, hypochlorite and chlorite should be introduced with at least one of these being dissolved in an appropriate solvent in advance. As this solvent, water can be used for example.

For instance, in adding the acidic substance to either one of them (hypochlorite or chlorite) being dissolved in a solvent in advance, if this mixing is executed under a pressurized condition, it is possible to restrict generation and accumulation of chlorine gas even more reliably. The pressurizing condition is not particularly limited, as long as the condition allows generation of chlorine dioxide upon execution of this mixing operation. However, if the operation is effected under the normal pressure, the production system can be simplified advantageously.

Furthermore, if the mixing operation is executed under a high temperature condition, the reaction of chlorine dioxide can be promoted. The temperature condition is not particularly limited as long as the condition allows generation of chlorine dioxide upon execution of this mixing operation. However, if the operation is executed at the normal temperature, the production system can be simplified advantageously.

If the production is carried out at the normal temperature and the normal pressure with adjustment of the reaction solution to pH 3 to 7, chlorine dioxide can be obtained with reaction efficiency of 95% or higher.

[Alkaline Composition for Chlorine Dioxide Production]

As described above, the present inventive method of producing chlorine dioxide is executed by mixing hypochlorite and chlorite in advance and subsequently adding an acidic substance to the resultant mixture solution. This mixture solution can be stored as an alkaline composition of chlorine dioxide production or distributed for commercial sales or the like.

In doing this, for the storage stability of the mixture solution, it is preferred that the mixture solution (alkaline composition for chlorine dioxide production) be contained within a cool storage container or a heat-insulated container. The specific temperature as the low temperature condition ranges from 3 to 20° C. for instance. If the temperature is below 3° C., this may lead to deterioration in the production efficiency of chlorine dioxide, whereas if the temperature exceeds 20° C., this may lead to reduction in the storage stability of the mixture solution (alkaline composition for chlorine dioxide production). Even more preferred temperature as the low temperature condition ranges from 5 to 15° C.

The cool storage container or the heat-insulated container described above can be any conventional container of such type.

### Example 1

Chlorine dioxide was produced by the present inventive method of producing chlorine dioxide. The reaction conditions were the normal temperature and the normal pressure.

In order to remove air from the reaction system, nitrogen gas as an inactive gas was charged into a plugged conical flask by a syringe, subsequently 1.00 ml of 7% sodium hypochlorite was introduced and to this solution, 1.74 ml of 10% sodium chlorite was added and then the mixture solution was stirred by a stirrer, as a stirring means, for a predetermined period (from several seconds to several minutes), thereby to mix them uniformly.

Furthermore, to this mixture solution, 1.05 ml of 7% hydrochloric acid was added and then these were stirred again under the same stirring conditions as above.

In the above, the molar ratios of the respective components are: sodium hypochlorite (NaClO): sodium chlorite (NaClO₂): hydrochloric acid (HCl)=1:2:2.

A portion of generated gas was taken by a syringe and bubbled in water, thereby to prepare an aqueous solution containing gas dissolved therein. By the conventional technique, this aqueous solution was confirmed as chlorine dioxide aqueous solution. The amount of chlorine dioxide generated was about 10000 ppm.

Also, the presence/absence of chlorine gas generation was checked as follows. With the use of a 25 ml syringe, ammonium gas was introduced into the plugged conical flask described above. If chlorine gas were present in the flask, generation of white smoke of ammonium chloride (NH₄Cl) could be confirmed. However, as shown in FIG. 1 (photo as drawing substitute), no white smoke was generated with the introduction of ammonium gas. Based on this, it was confirmed that with the present inventive method of producing chlorine dioxide, chlorine dioxide can be produced without generation and subsequent accumulation of chlorine gas.

Moreover, with the use of a conventional technique, the presence/absence of generation of chlorate (sodium chlorate) was checked. This technique can be e.g. the iodine titration technique. In this technique, potassium iodide is oxidized in an acidic solution for isolating iodine. Then, this iodine is titrated in a sodium thiosulfate solution with a starch solution as an indicator, thereby to determine chlorine dioxide, chlorite ion and chlorate ion.

As a result, no generation of chlorate was observed in the case of the present inventive method of producing chlorine dioxide.

### Example 2

In the present inventive method of producing chlorine dioxide, in order to remove air from the reaction system, nitrogen gas as an inactive gas was charged into a plugged conical flask by a syringe, subsequently 1.00 ml of 7% sodium hypochlorite was introduced and to this solution, 1.74 ml of 10% sodium chlorite was added and then these were stirred under the same stirring conditions as Example 1 and thereafter, the resultant mixture solution was stored at 5° C. for two months. Then, this mixture solution was prepared as an alkaline composition for chlorine dioxide production. After the two-month storage, to this mixture solution, 1.05 ml of 7% hydrochloric acid was added and then the mixture solution was stirred again.

A portion of generated gas was taken into a syringe and bubbled in water, thereby to prepare an aqueous solution containing gas dissolved therein. By the conventional technique, this aqueous solution was confirmed as chlorine dioxide aqueous solution.

Furthermore, the presence/absence of chlorine gas generation was checked as follows. With the use of a 25 ml syringe, ammonium gas was introduced into the plugged conical flask described above. If chlorine gas were present in the flask, generation of white smoke of ammonium chloride (NH₄Cl) could be observed. However, no white smoke was generated with the introduction of ammonium gas. Based on this, it was confirmed that in the case also of storing the alkaline composition for chlorine dioxide, a mixture of hypochlorite and chlorite, under a low temperature condition for a predetermined period, chlorine dioxide can be produced without generation and subsequent accumulation of chlorine gas. Furthermore, as a result of determination by the conventional technique, no generation of sodium chlorate (chlorate) was observed.

### Comparison Example 1

### Three-Liquid Component Simultaneous Introduction

As a comparison control, an experiment as follows was conducted. In order to remove air from the reservoir system, nitrogen gas as an inactive gas was charged into a plugged conical flask by a syringe, subsequently 1.00 ml of 7% sodium hypochlorite, 1.74 ml of 10% sodium chlorite and 1.05 ml of 7% hydrochloric acid were introduced simultaneously and these were stirred together. With the use of a 25 ml syringe, ammonium gas was introduced into the plugged conical flask described above. After this introduction, as shown in FIG. 2 (photo substitute for drawing), white smoke of ammonium chloride (NH₄Cl) was generated in the flask. Based on this observation, it was confirmed that the co-presence of sodium hypochlorite and hydrochloric acid results in the generation of chlorine gas.

According to one non-invention binding theoretical explanation on the above, when sodium hypochlorite, sodium chlorite and hydrochloric acid were mixed simultaneously, if i.e. hypochlorite and chlorite were not mixed uniformly, chlorine gas was generated from a reaction between sodium hypochlorite and hydrochloric acid and as this chlorine gas generated could not react immediately with the sodium hypochlorite, accumulation of the generated chlorine gas occurred.

In this experiment, it was found that the reactions of Chemical Formula 1 and Chemical Formula 2 occurred and the chlorine gas generation was confirmed by the reaction between the accumulated chlorine gas and ammonium gas.

### Comparison Example 2

### Conventional Method

As a comparison control, an experiment as follows was conducted. In order to remove air from the reservoir system, nitrogen gas as an inactive gas was charged into a plugged conical flask by a syringe, subsequently 1.00 ml of 7% sodium hypochlorite was introduced. To this, 1.05 ml of 7% hydrochloric acid was added and the mixture solution was stirred together. Furthermore, to this mixture solution, 1.74 ml of 10% sodium chlorite was introduced and these were stirred again.

With the use of a 25 ml syringe, ammonium gas was introduced into the plugged conical flask described above. After this introduction, as shown in FIG. 3 (photo substitute for drawing), the inside of the flask became hazy with white smoke of ammonium chloride (NH₄Cl). Based on this observation, the presence of a great amount of chlorine gas was confirmed (see Chemical Formulae 1 and 2).

### INDUSTRIAL APPLICABILITY

The present invention can be used in production of chlorine dioxide with hypochlorite, chlorite and an acidic substance.

1. A method of producing chlorine dioxide with the use of hypochlorite, chlorite and an acidic substance, wherein:
the method comprises the steps of mixing the hypochlorite and the chlorite in advance and subsequently adding the acidic substance to the resultant mixture solution.

2. The method of producing chlorine dioxide according to claim 1, wherein the method is executed with preventing introduction of air to a tank reserving the hypochlorite.

3. The method of producing chlorine dioxide according to claim 1, wherein a mixing ratio of the acidic substance is set to 2 mol or less, relative to 1 mol of the hypochlorite.

4. An alkaline composition for use in production of chlorine dioxide with addition of an acidic substance, wherein:
said alkaline composition comprises a mixture of hypochlorite and chlorite.

5. The alkaline composition for use in production of chlorine dioxide according to claim 4, wherein said alkaline composition is stored at a low temperature.

6. The method of producing chlorine dioxide according to claim 2, wherein a mixing ratio of the acidic substance is set to 2 mol or less, relative to 1 mol of the hypochlorite.
